(19) United States
(12) Patent Application Publication
(10) Pub. No.: US 2026/0293947 A1
(43) Pub. Date: Oct. 1, 2026

(54) PRAHOK FOOD ADDITIVE COMPOSITION

(71) Applicant: Ly Eang HAY, COURBEVOIE (FR)

(72) Inventor: Ly Eang HAY, COURBEVOIE (FR)

(21) Appl. No.: 19/489,120

(22) PCT Filed: Apr. 5, 2024
(86) PCT No.: PCT/FR2024/050450

§ 371 Date: Dec. 1, 2025

(30) Foreign Application Priority Data
Jun. 5, 2023 (FR) FR2305613

(51) Int. Cl. A23L 17/10; A23L 17/00; A23L 27/00; A23L 27/24

(52) U.S. Cl. CPC A23L 17/10; A23L 17/65; A23L 17/70; A23L 27/24; A23L 27/74

(57) ABSTRACT

A Prahok food additive composition is provided as well as a process for manufacturing the Prahok food composition as a powder. The Prahok food additive may be employed in any food as a food additive.

The present invention relates to a prahok food additive composition, to a process for manufacturing a prahok food composition powder, to the use of such a prahok food additive composition as a condiment, and also to any food comprising such a prahok food additive composition.

### PRIOR ART

CN106262734 discloses a process for preparing a condiment based on fish sauce. CN104286572 discloses a food for turtles.

For centuries, prahok has been at the heart of local Cambodian cuisine, deeply rooted in Cambodian culture. Today, the condiment, whose unpleasant odor (characterized as pungent) has a reputation for “driving away many tourists”, nevertheless continues to be a “star” ingredient in a wide range of vegetable, meat and rice dishes, and also soups. Originally, prahok was a means of preserving fish during the dry season in Cambodia. For many of Cambodia's poorest inhabitants, this preserved fish was an important (or even the sole) source of protein.

Thus, Cambodian culinary products are increasingly consumed outside Southeast Asia, but are the subject of remarkably few reports. Khmer culture and the culinary traditions of the Cambodian people, both historical and contemporary, depend essentially on the fermented fish product called prahok (sometimes also spelled prahoc or prohoc) as the essential ingredient in a wide variety of dishes.

Prahok is also produced in Vietnam and can even be found as far as the United States, imported for the Cambodian diaspora.

Prahok is prepared from various species of fresh fish, notably moonlight gouramis and channa.

Thus, this product has cultural significance for Cambodia's history and tradition in terms of fish preservation, production methods and the uses of prahok, as well as the storage of this essential aromatic and nutritional element of Khmer cuisine.

The diet of the Khmer people of Cambodia is based mainly on rice and fish. Cambodians are among the largest consumers of fish. Due to the seasonal availability of fish, there has been a strong historical incentive to use efficient, inexpensive, and low-energy processes for preserving fish. Traditionally, prahok was an essential element of the Cambodian diet, as it was vital for the nutrition and food security of rural families.

The traditional method of prahok manufacture consists in crushing the fish with the foot. Depending on its quality, prahok may be stored for anywhere from a few weeks to several years. Nowadays, the process is mainly done using machines that chop and mix the fish instead of the traditional foot method.

There are two main types of prahok. Prahok ch′oeung contains fish bones throughout the production process. Prahok sach, on the other hand, is manufactured by first removing the fish bones. Both types of prahok are manufactured by first removing the head, scaling, and cleaning the fish. Traditionally, the scaling and cleaning were performed by placing the fish in a flat basket at the river's edge and walking on the fish until the scales were taken up by the river's current.

Prahok ch′oeung is manufactured from the tiny bones of small fish, which soften during fermentation.

Prahok sach is prepared either by filleting large snakehead fish and discarding the bones, or by cutting it into steaks.

The prepared fish is then mixed with salt in a relatively low concentration, generally 4-5%, and left to soak in baskets overnight. This early fermentation process is intended to afford a highly desirable by-product called “teuktrey” (fish sauce). Certain types of prahok are manufactured by drying the fish in the sun and crushing or grinding them with a mortar or sometimes even with the feet.

The fish is again salted with 15-20% salt to make prahok ch′oeung or 25-30% salt to make prahok sach. Fermentation takes place without aeration, stirring or shaking, as exposure to oxygen causes a bad odor and the formation of granules that compromise the quality. The mixture is left to ferment in sealed plastic, earthenware, metal, or concrete tanks for several months or even a year. The best fermented fish may be stored for up to three years.

While historically other sources of protein were not available during the dry season, in modern Cambodia advances in agricultural technology and increased importation of other animal products have made other sources of protein more readily available. However, the traditional incentive to treat fish and increase its storage duration without preserving technology such as refrigeration remains.

Prahok remains a vital and widely consumed element of the Cambodian diet, prized for its powerful umami flavor in a wide variety of sauces, dips, soups and main dishes.

Khmer cooks use prahok generously to add flavor to almost every dish. Prahok is enjoyed in meals throughout the day, and the Khmer people attest that “without its odor and flavor, food is not delicious”. Prahok is also used as a sauce for dipping food or simply mixed into a bowl of rice. Its powerful flavor is quite pungent and has been compared to the taste of old French cheese with a fishy odor. Cambodian culinary secrets have rarely been written down; recipes have been passed down from generation to generation and vary somewhat in different regions of the country. Traditional ancient cuisine blends prahok with other unique flavors and colors so as to enhance the flavor and aroma of each ingredient. Cambodians have perfected the art of blending spices into fish pastes by using ingredients such as cloves, cinnamon, star anise, nutmeg, cardamom, ginger and turmeric.

Dried peppers, sweet peppers and chili peppers are also used according to taste and to add color. The features of a Cambodian cook's kroeung are different and considered as a measure of respect in Khmer culture. Kroeung and prahok mixed together form a unique aromatic combination that is the most distinctive ingredient in Khmer cuisine. These ingredients and other essential ingredients such as tamarind, lemongrass, basil, sugar and lime (commonly known as lemon in Cambodia) flavor sauces, soups, stir-fries and many other foods.

Many prahok dishes are best enjoyed with a variety of vegetables, a combination that has the added benefit of improving the nutritional quality of Cambodian foods by increasing the bioavailability of the nutrients in prahok, including protein, vitamin A, calcium, iron, zinc and iodine.

The impressive range of nutritional benefits afforded by prahok is the result of components such as:
protein: prahok provides amino acids that are essential for the human diet;
iodine: when prepared with iodized salt, prahok adds iodine to food; or even
beneficial bacteria: because it is a fermented food, prahok contains bacteria that may be beneficial to intestinal health.

By integrating prahok into food, it is possible to treat or prevent health problems such as:
a weak immun system: by virtue of its bacteria, prahok can increase healthy bacteria in the gut and reinforce the immune system;
goiter: goiter is an enlargement of the thyroid gland. It is a symptom of iodine deficiency, which prahok can help combat; or
obesity: prahok contains relatively few calories. It can thus be used to add flavor to a meal without significantly affecting weight gain.

However, prahok has some appreciable drawbacks:
it is known for its intensely pungent fish flavor. This flavor is particularly strong for foreigners (non-Cambodians) who tend to compare the fermented taste to that of “super-fresh” cheeses. Cambodian restaurateurs are moreover known to limit the amount of prahok used in dishes they serve to foreigners because of its intensity;
it contains a lot of salt, which is used for preserving prahok. One serving can represent a significant portion of the recommended daily intake of sodium. However, too much salt can have a negative effect on blood pressure and cause various other health problems; or
on account of its distinctive odor, special care must be taken when storing prahok.

One of the aims of the present invention thus consists in finding a prahok composition that has the strengths identified above while at the same time eliminating its listed weaknesses.

This aim, and also others, is achieved by the composition developed in the context of the present invention.

Thus, one subject of the present invention relates to a prahok food additive composition, characterized in that the composition comprises:
prahok, and
at least one flavor fixative.

Specifically, it has been discovered that the addition of at least one flavor fixative (which may moreover be a flavor enhancer) allows maintenance of the identified advantages while at the same time eliminating prahok's known drawbacks listed above.

A flavor fixative can fix the aromatic fraction of a food composition by, for example, preventing or reducing the rate of evaporation of the most volatile components of the composition (which can occur during the Maillard reaction, for example). Such products are known in the art, as evidenced by the teaching of EP 0 030 327 B1.

According to certain embodiments, the prahok is a prahok in paste form. According to these embodiments, prahok paste is in a deformable or undeformable solid state, within the meaning of the three states of matter (gas, liquid and solid).

Preferably, the amount of water included in the composition according to the present invention is less than or equal to 10% by weight relative to the total weight of the composition, more preferentially less than or equal to 5%, less than or equal to 4%, less than or equal to 3%, less than or equal to 2%, or even less than or equal to 1% by weight relative to the total weight of the composition.

Advantageously, the composition according to the present invention is dry. In these advantageous embodiments, the composition is substantially water-free.

According to some of these embodiments, the composition is in the form of a dry solid in a divided state. According to certain embodiments, the composition is in the form of a dry powder. Such a dry powder may be obtained from an ancestral prahok paste. Specifically, the absence of water improves the storage, olfactory and odor properties, presentation aspect and modes of use of prahok.

In a particular embodiment, the composition according to the present invention is characterized in that the prahok is a prahok powder. Specifically, in the absence of water or at least with a low amount of water in the composition, the prahok is advantageously in powder form. Surprisingly, prahok powder improves the olfactory properties and taste of prahok.

Preferably, the flavor fixative is chosen from the list of adjuvants consisting of starch, maltodextrin, potato powder, dried fruit powder, milk powder, pepper, ginger, lemongrass, bitter orange peel, garlic, cinnamon, turmeric, and any mixture thereof.

Preferably, the flavor fixative comprises maltodextrin and/or milk powder.

Preferably, the flavor fixative comprises maltodextrin.

Preferably, the flavor fixative comprises milk powder.

Advantageously, the flavor fixative is a combination of maltodextrin and milk powder.

In a particular embodiment, the amount of prahok is between about 10% and about 90%, preferentially about 50%, by mass relative to the total mass of the composition.

For example, the amount of prahok is between 20% and 80%, such as between 30% and 70%, between 40% and 60%, or between 45% and 55% by mass relative to the total mass of the composition.

Advantageously, the amount of each flavor fixative is between 10% and 60%, preferentially 25%, by mass relative to the total mass of the composition.

For example, the amount of each flavor fixative is between 15% and 45%, such as between 20% and 30%, or between 22% and 27% by mass relative to the total mass of the composition.

A subject of the present invention also relates to a process for manufacturing a prahok food composition powder as described above, characterized in that the process comprises the following successive steps:
a) soaking prahok in water for 6 to 24 hours, preferentially 8 to 12 hours,
b) draining the water from the mixture obtained in step a) to obtain a paste,
c) chopping and mixing the paste obtained in step b),
d) adding at least one flavor fixative to the product obtained in step c), and
e) drying the product obtained in step d) until a powder is obtained, for example by heating or drying on a hot frying pan (in particular over a low heat).

The soaking in step a) is typically performed at room temperature, for example between 1° C. and 50° C., preferentially between 10° C. and 40° C., between 15° C. and 30° C., or between 20° C. and 25° C.

The draining in step b) may be done by any known draining technique, for example by the use of a static drainer with apertures for the fluid to flow out.

In a particular embodiment, after step b) of draining the prahok, a fermented solution with an acidic pH is added, based on plant(s) containing at least one active/live probiotic, such as a solution based on fruits such as noni and/or papaya, and/or a solution based on vegetable(s). In this manner, the unpleasant odor of prahok can be even further reduced or even eliminated. Specifically, such a solution of at least one live probiotic makes it possible to reduce or even eliminate the odor of the fish paste and can also be used in varying doses to deodorize prahok according to the producer's wishes.

Advantageously, the pH of the fermented solution is less than or equal to 4, preferentially less than or equal to 3.5, or less than or equal to 3. The acidity of the fermented solution allows it to increase its effect on reducing or even eliminating the odor of prahok.

Advantageously, the active/live probiotic comprises at least one effective active/live microorganism (such as a fermented solution of “KEM®” (for “Khmer Effective Microorganisms,” a trademark registered by the company CONFIREL®) and corresponding to a variety of chosen combinations of lactic acid bacteria, yeasts, and phototrophic bacteria with syntrophic characteristics. According to certain embodiments, the fermented solution, notably the fermented solution of the “KEM®” type, comprises a symbiotic and/or syntrophic combination of at least one lactic acid bacterium, at least one yeast, and at least one phototrophic bacterium.

The chopping and mixing in step c) may be performed using any known technique, for example using a mixer with moving blades, for instance a mixer with rotating blades.

The addition of at least one flavor fixative to the product obtained in step c) is typically performed in a controlled manner by weighing or measuring out the amount of flavor fixative(s) and/or product obtained in step c) before addition.

The drying in step e) of the product obtained in step d) until a powder is obtained may be performed using any known technique, such as heating or under vacuum, for example by freeze-drying.

Preferably, the flavor fixative added in step d) is chosen from the list of adjuvants consisting of starch, maltodextrin, potato powder, dried fruit powder, milk powder, pepper, ginger, lemongrass, bitter orange peel, garlic, cinnamon, turmeric, and any mixture thereof.

More preferably, the flavor fixative added in step d) comprises maltodextrin and/or milk powder.

More preferably, the flavor fixative added in step d) comprises maltodextrin.

More preferably, the flavor fixative added in step d) comprises milk powder.

A subject according to the present invention also relates to a powdered food composition of prahok that can be obtained via the processes described above, notably with, after step b) of draining prahok, the addition of a fermented solution (KEM), at acidic pH, based on plant(s) containing at least one active probiotic such as a solution based on fruits such as noni and/or papaya, and/or a solution based on vegetable(s).

Even more preferably, the manufacturing process according to the present invention is characterized in that said at least one flavor fixative is a combination of maltodextrin and milk powder.

A subject of the present invention also relates to the use of a prahok food additive composition as described above as a condiment.

Thus, the subject of the present invention relates to the use of a prahok food additive composition to be added to cooked or raw foods to enhance their flavor, i.e. as a condiment.

Thus, a subject of the present invention relates to a food comprising a prahok food additive composition as described above.

According to certain embodiments, the food is chosen from the group consisting of omelets, pizzas, meat in sauce, grilled meat, sandwiches, burgers, spaghetti and rice-based dishes, pancakes and tapas.

The examples that follow are provided to illustrate the invention.

### EXAMPLES

### Example 1: Preparation of the Mixture According to the Invention

Composition per 100 g:

| | |
|---|---|
| prahok (fermented fish paste) | 50 g |
| maltodextrin | 25 g |
| milk powder | 25 g |

### Preparation:

Soak 50 g of prahok in water and leave overnight to remove the excess salt. Drain and remove the fish paste from the water, and then chop the drained paste into small pieces. Mix with the maltodextrin/milk powder mixture (25 g/25 g) and place the whole in a frying pan over a low heat. Stir the mixture in the frying pan over a low heat until it becomes dry.

An example of ready-to-use dry prahok with a mild flavor is thus obtained.

### Example 2: Variant in the Preparation of the Mixture According to the Invention

Composition per 100 g:

| | |
|---|---|
| prahok (fermented fish paste) | 50 g |
| maltodextrin | 25 g |
| milk powder | 25 g |

### Preparation:

Soak 50 g of prahok in water for 6 hours to remove the excess salt. Drain and remove the fish paste from the water, and then add between 0.5 ml and 2 ml (depending on the desired effect on the odor and/or the desired effect on the final aroma) of the probiotic fermented solution (KEM® at pH 3) to the drained paste and leave to stand for between 3 and 24 hours depending on the chosen aroma, i.e. from a total absence of odor to a more subtle odor.

Then chop this paste into small pieces. Mix the pieces thus obtained with a mixture of maltodextrin and milk powder (25 g/25 g) and place the whole in a frying pan over a low heat. Stir the mixture in the frying pan over a low heat until it becomes dry.

An example of deodorized dry prahok is thus obtained. This powder, called “KEM prahok powder”, has an even less pronounced odor than in Example 1 and may be used as a variant of an ingredient in various culinary preparations, for example for people who cannot tolerate the smell of prahok (depending on the amount of probiotic fermented solution and/or the standing time with this solution applied). Depending on how long the fish paste is left to stand in contact with the probiotic fermented solution, different varieties of prahok powder are obtained with increasing intensity of flavor, from a “light” prahok powder to a “full-bodied” prahok powder, passing through a “regular” prahok powder.

### Example 3: Full-Bodied Prahok Powder

Composition per 100 g:

| | |
|---|---|
| prahok | 50 g |
| maltodextrin | 35 g |
| milk powder | 15 g |

The preparation is as given in Examples 1 or 2.

### Example 4: Prahok Powder Flavored with Lime Leaves

Composition per 100 g:

| | |
|---|---|
| prahok | 44.44 g |
| lime leaves | 5.56 g |
| garlic | 5.56 g |
| maltodextrin | 22.22 g |
| milk powder | 22.22 g |

The preparation is as given in Examples 1 or 2.

### Example 5: Prahok Powder Flavored with Galangal

Composition per 100 g:

| | |
|---|---|
| prahok | 42.10 g |
| galangal | 5.26 g |
| garlic | 5.26 g |
| lemongrass | 5.26 g |
| maltodextrin | 21.06 g |
| milk powder | 21.06 g |

The preparation is as given in Examples 1 or 2.

### Example 6: Omelet with Dried Prahok

Break two eggs into a bowl. Next, add a teaspoon of the dry prahok mixture.

Beat the egg and prahok mixture (a little salt, pepper, carrot, onion or garlic may also be added).

Pour the eggs into a frying pan over a low heat and fold using a spatula, and then fold the omelet in half and continue cooking for about one minute.

### Example 7: Prahok Pizza

Prepare the pizza dough and add the topping based on tomato sauce and herbs, a little ham and mozzarella, and a teaspoon of dried prahok powder.

Bake in a pizza oven at 220° C. for 10 to 12 minutes.

An example of a prahok pizza is thus obtained.

### Example 8: Prahok Ktis or Prahok with Coconut Milk

This is a traditional dish that is very popular with consumers.

Cook 150 g of minced pork in a hot frying pan with two teaspoons of pigment oil. Next, add two teaspoons of prahok powder with garlic and red pigment until cooked through. Finally, add one to two teaspoons of coconut milk. An example of prahok ktis is thus obtained.

### Example 9: Flavored Chicken Prahok Ktis (Prahok with Coconut Milk)

The ingredients are as follows: 150 g of coconut milk, 100 g of shallots and garlic, 30 g of chili peppers, 40 g of olive oil, 25 g of palm sugar, 300 g of chicken, 25 g of condensed milk and 70 g of prahok powder flavored with lime leaves (as described in Example 4). The prahok powder may be obtained via the process as described in Examples 1 and 2. The dish is garnished with lime leaves and strips of fresh red pepper. The chicken may advantageously be replaced with beef, pork or fish to propose beef prahok ktis, pork prahok ktis, or fish prahok ktis, respectively.

### Example 10: Prahok Ktis Pizza (Pork, Beef or Seafood)

Prepare or obtain a pizza dough, a portion of tomato sauce suitable for the pizza dough piece, 100 g of prahok with coconut milk (prahok ktis as described in Example 5), 50 g of ground meat, 5 mL of olive oil and 5 g of prahok powder as described in Example 1 or 2. The ground meat may be pork, beef, or seafood meat.

### Example 11: Special Prahok Omelet

The ingredients are as follows: two hen's eggs, 5 g of “regular” prahok powder, 5 g of radicchio lettuce, 5 g of lollo rossa lettuce, 5 g of romaine lettuce, 5 g of curly endive lettuce, 5 g of iceberg lettuce, a portion of vinaigrette, 10 g of red tomato, 5 g of Kampot pepper corn, 20 g of salt, 10 g of pepper, 20 mL of corn oil, 10 g of red pepper, 10 g of green pepper, and 5 g of prahok caviar. Then proceed as in Example 3.

### Example 12: Prahok Ktis Sandwich with Beef, Pork or Chicken

The ingredients are as follows: 150 g of bread, 80 g of prahok ktis chicken or prahok ktis pork or prahok ktis beef (as described in Example 6), 30 g of tomato sauce, 20 g of prahok sauce with Kampot pepper, 20 g of lettuce, 20 g of carrots, 20 g of long beans, 20 g of Khmer vegetables, 20 g of cucumber, 20 g of white cabbage, 20 g of Khmer eggplant, 5 g of prahok powder flavored with lime leaves (as described in Example 4), 30 g of green lettuce. French fries can accompany this prahok ktis beef, pork or chicken sandwich.

### Example 13: Prahok Ktis Pork, Beef, Chicken or Fish Platter

The ingredients are as follows: 120 g of prahok ktis pork or prahok ktis beef or prahok ktis chicken or prahok ktis fish, 30 g of eggplant, 20 g of long beans, 30 g of carrots, 30 g of cucumber, 30 g of white cabbage, 50 g of banana blossoms, 30 g of Northwest, 5 g of prahok powder flavored with lime leaves (as described in Example 4), one serving of prahok fried rice, and 50 g of coconut milk.

### Example 14: Prahok Fried Rice Platter

The ingredients are as follows: 80 g of rice, 20 g of carrots, 20 g of cauliflower, 20 g of broccoli, 1 egg, 15 mL of plant oil, 10 g of salt, 5 g of pepper, one serving of Asian sauce, 30 g of red tomato, 30 g of cucumber, 25 g of prahok powder (“regular”), 30 g of eggplant, 20 g of long beans, 30 g of white cabbage, and 30 g of Northwest.

### Example 15: Beef Prahok in Lok Lak Sauce

The ingredients are as follows: 130 g of beef, 510 g of onion, 50 g of red tomato, 20 g of carrot, 20 g of broccoli, 15 mL of vegetable oil, 10 g of salt, 5 g of pepper, 40 g of prahok sauce with Kampot pepper, one serving of prahok fried rice, 5 g of prahok powder flavored with lime leaves (as described in Example 4), and one egg.

### Example 16: Spaghetti with Beef Prahok Ktis

The ingredients are as follows: 100 g of spaghetti, 80 g of beef prahok ktis, 70 g of tomato sauce, and 5 g prahok powder flavored with lime leaves (as described in Example 4).

### Example 17: Special Prahok Ktis Burger

The ingredients are as follows: one hamburger bun, 100 g of ground beef, 30 g of iceberg lettuce, 50 g of tomato, 30 g of onion, 20 g of romaine lettuce, 10 g of radicchio lettuce, 10 g of curly lettuce, 10 g of lollo rossa lettuce, 100 g of French fries, 20 g of ketchup, 10 g of salt, 5 g of pepper, 20 mL of corn oil, and 50 g of beef prahok ktis.

### Example 18: Grilled Beef Fillet with Prahok Sauce

The ingredients are as follows: 170 g of tenderloin, 10 g of lollo rossa lettuce, 10 g of curly lettuce, 10 g of iceberg lettuce, 10 g of radicchio lettuce, 10 g of romaine lettuce, 10 g of salt, 5 g of pepper, 20 mL of corn oil, 40 g of prahok Kampot pepper sauce, 10 g of French fries.

These examples are given for purely illustrative purposes and do not in any way limit the scope of the invention.

1. A prahok food additive composition comprises:
prahok, and
at least one flavor fixative, wherein the composition is dry.

2. The composition as claimed in claim 1, wherein the prahok is prahok powder.

3. The composition as claimed in claim 1, wherein the flavor fixative is chosen from the list of adjuvants consisting of starch, maltodextrin, potato powder, dried fruit powder, milk powder, pepper, ginger, lemongrass, bitter orange peel, garlic, cinnamon, turmeric, and any mixture thereof.

4. The composition as claimed in claim 1, wherein the flavor fixative is a combination of maltodextrin and milk powder.

5. The composition as claimed in claim 1, wherein the amount of prahok is between 10% and 90% by mass relative to the total mass of the composition.

6. The composition as claimed in claim 1, wherein the amount of each flavor fixative is between 10% and 60% by mass relative to the total mass of the composition.

7. A process for manufacturing a powdered food composition of prahok as claimed in claim 1, wherein the process comprises the following successive steps:
a) soaking prahok in water for 6 to 24 hours,
b) draining the water from the mixture obtained in step a) to obtain a paste,
c) chopping and mixing the paste obtained in step b),
d) adding at least one flavor fixative to the product obtained in step c), and
e) drying the product obtained in step d) until a powder is obtained.

8. The manufacturing process as claimed in claim 7, wherein said at least one flavor fixative is a combination of maltodextrin and milk powder.

9. The manufacturing process as claimed in claim 7, wherein after step b) of draining the prahok, a fermented solution is added, such as KEM, with an acidic pH, based on plant(s) containing at least one active probiotic such as a solution based on fruits such as noni and/or papaya, and/or a solution based on vegetable(s).

10. The manufacturing process as claimed in claim 9, wherein the fermented solution comprises a symbiotic and/or syntrophic combination of at least one lactic acid bacterium, at least one yeast, and at least one phototrophic bacterium.

11. A prahok food additive composition as claimed in claim 1, wherein said prahok food additive is configured for its use as a condiment.

12. A food comprising a prahok food additive composition as claimed in claim 1.

13. The food as claimed in claim 12, wherein said food is chosen from the group consisting of omelets, pizzas, meat in sauce, grilled meat, sandwiches, burgers, spaghetti and rice-based dishes, pancakes and tapas.
